(19) United States
(12) Patent Application Publication
(10) Pub. No.: US 2025/0108490 A1
(43) Pub. Date: Apr. 3, 2025

(54) MACHINE AND METHOD FOR RUNNING A MACHINE

(71) Applicant: Hilti Aktiengesellschaft, Schaan (LI)

(72) Inventors: Christoph STUERTZEL, Sigmarszell (DE); Matthias VON MONKIEWITSCH, Bregenz (AT); Andreas WETTSTEIN, Feldkirch (AT)

(21) Appl. No.: 18/725,404

(22) PCT Filed: Jan. 23, 2023
(86) PCT No.: PCT/EP2023/051501

§ 371 Date: Jun. 28, 2024

(30) Foreign Application Priority Data
Feb. 7, 2022 (EP) 22155380.3

(51) Int. Cl. B25B 23/147; B25B 21/00

(52) U.S. Cl. CPC B25B 23/147; B25B 21/00

(57) ABSTRACT

A machine and a method for setting a screw is provided, wherein the machine comprises a motor and a trigger, includes providing electric current to the motor upon pulling the trigger. A pattern according to which the trigger is pulled may be determined and the motor may be controlled to run in a first mode of operation if the trigger is pulled according to a first pattern or in a second mode of operation if the trigger is pulled according to a second pattern.

### TECHNICAL FIELD

Described herein are machines and methods for running the machines to set screws. Also described are hand-held power tools for enabling screw-setting actions. Typically, such hand-held tools find a widespread use in the construction industry. A typical hand-held tool as intended to be covered by the scope of the present invention includes, but is not limited to, an automatic screw driver for screwing screw fasteners into a workpiece, thereby penetrating the workpiece, such as a steel or metal frame, with a screw fastener.

### BACKGROUND ART

Hand-held power tools are known to enable setting actions of a screw. The tools comprise at least a machine housing including at least a motor that provides at least rotary motion to a rotary shaft upon pulling a trigger. The rotary shaft, in turn, will ultimately transmit a certain torque at a certain rotational speed to a workpiece penetrating element, such as, for example, a screw fastener. A tool may also comprise a controller, for controlling the motor and continuously determining the delivered torque and rotational speed of the rotary shaft when the tool is in use.

Different fields of application may require different modes of operation of the motor, such as different rotational speeds or different torques. A tool may be provided with a mode switch to enable a user to switch between such different modes of operation.

### SUMMARY

According to one aspect, a method for running a machine to set a screw along a setting axis into a workpiece, wherein the machine comprises a motor configured to provide rotational energy to the screw and a trigger configured to be pulled by a user of the machine, comprises providing electrical current to the motor to run the motor at a rotational speed and a torque upon pulling the trigger, determining, or electronically determining, a pattern according to which the trigger is pulled, controlling the motor to run in a first mode of operation if the trigger is pulled according to a first pattern, and controlling the motor to run in a second mode of operation if the trigger is pulled according to a second pattern. Optionally, the motor is run in a third mode of operation if the trigger is pulled according to a third pattern. The machine may thereby be switched between two or more modes of operation by an easy-to-learn handling using one hand only. Also, the cost and weight of a separate switch or additional gear stage may be avoided.

According to an embodiment, the second mode of operation is different from the first mode of operation in terms of at least one of a voltage of the electric current provided to the motor, a maximum amperage of the electric current provided to the motor, a maximum rotational speed of the motor, and a combination thereof.

According to another embodiment, the second pattern is different from the first pattern in terms of at least one of a travelled distance of a pulling action, a speed of a pulling action, a duration of a pulling action, a number of pulling actions within a predefined time interval, a time interval between two pulling actions, a frequency of pulling actions, and a combination thereof.

According to another embodiment, the method further comprises memorizing which mode of operation the motor is controlled to run in and defining such a mode as the first mode of operation for a subsequent execution of the method. According to a preferred embodiment, a memorized mode of operation of a previous execution of the method is used as the first mode of operation, and a mode of operation immediately following the memorized mode of operation within a predefined cyclic order of modes of operation is used as the second mode of operation.

According to another aspect, a machine for setting a screw along a setting axis into a workpiece comprises a motor configured to provide rotational energy to the screw, a trigger configured to be pulled by a user of the machine, a controller configured to provide electrical current to the motor to run the motor at a rotational speed and a torque upon pulling the trigger, determine a pattern according to which the trigger is pulled, control the motor to run in a first mode of operation if the trigger is pulled according to a first pattern, and control the motor to run in a second mode of operation if the trigger is pulled according to a second pattern.

According to an embodiment, the controller is further configured to one or more of electronically determine the pattern according to which the trigger is pulled, control the motor to run in a third mode of operation if the trigger is pulled according to a third pattern, memorize which mode of operation the motor is controlled to run in and define such a mode as the first mode of operation for a subsequent execution of the method, use a memorized mode of operation as the first mode of operation, and a mode of operation immediately following the memorized mode of operation within a predefined cyclic order of modes of operation as the second mode of operation.

According to an embodiment, the machine comprises a press-on switch provided for generating a press-on signal when a force towards the machine along the setting axis is applied to the shaft. The controller may be provided for receiving the press-on signal and starting the motor upon receipt of the press-on signal.

### BRIEF DESCRIPTION OF THE DRAWINGS

Further aspects and advantages of the machine, associated parts and a method of use thereof will become apparent from the ensuing description that is given by way of example only and with reference to the accompanying drawings in which:

FIG. 1 shows a machine,

FIG. 2 shows an exemplary characteristic of a distance traveled by a trigger over time, and

FIG. 3 shows an exemplary characteristic of a rotational speed of a motor over time.

### DETAILED DESCRIPTION

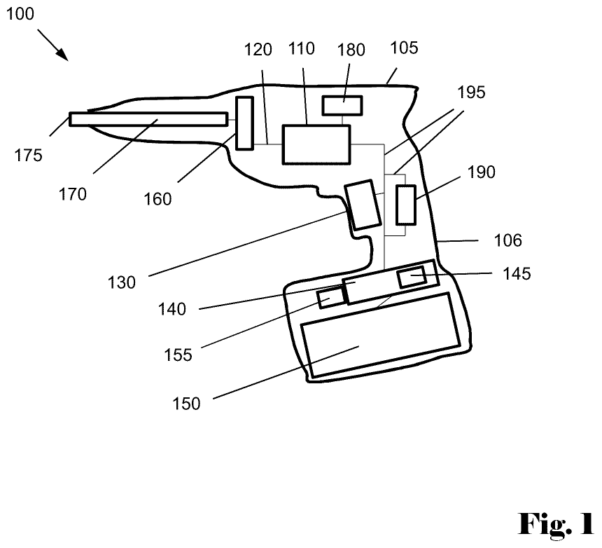

FIG. 1 shows a machine 100 for setting a screw into a workpiece (not shown). In the embodiment shown, the machine 100 is formed as a hand-held working tool such as an automatic screwdriver. The machine 100 comprises a housing 105 and, enclosed by the housing 105, a motor 110 having a shaft 120, a trigger 130, a controller 140 formed as a microcomputer and having a data storage 145 formed as a computer memory, a battery 150, and a communication unit 155 formed as a wireless transmitter. The controller 140 provides electric current from the battery 150 to the motor 110 to rotationally drive the shaft 120. The machine 100 further comprises a gear 160 and a spindle 170 having a screw drive 175 such as a hex drive and driven by the shaft 120 via the gear 160. A longitudinal direction of the spindle 170 defines a setting axis along which the screw will be set into the workpiece.

Further, the machine 100 comprises a rotational-speed sensor 180 for detecting a rotational speed of the motor 110 and an amperage/voltage sensor 190 for detecting an amperage and/or voltage of the electric current provided to the motor 110. The amperage of the motor 110 may be used as a parameter representing a torque transmitted to the screw. Further, the machine 100 comprises lines 195 which connect the controller 140 with the motor 110, the switch 130 and sensors 180, 190 for transmitting electric current to the motor 110 and/or collecting electric signals from the trigger 130 and/or sensors 180, 190. Additionally, or alternatively, to acquire data on the rotational speed, amperage or voltage of the motor 110, the controller 140 may use information already present from its controlling a rotational movement of the motor 110, for example the number of electrical commutations over time for the rotational speed.

The housing 105 comprises a grip section 106 for manually gripping the machine 100 by a user such that the trigger 130 can be pressed by the user's index finger. The trigger 130 is capable of signaling its switch position to the controller 140 via the lines 195, wherein the controller 140 electronically uses that switch position of the trigger 130 to electronically determine a pattern according to which the trigger 130 is pulled. Upon pulling the trigger 130 by the user, the motor 110 is provided with electrical current depending on the pattern determined by the controller 140.

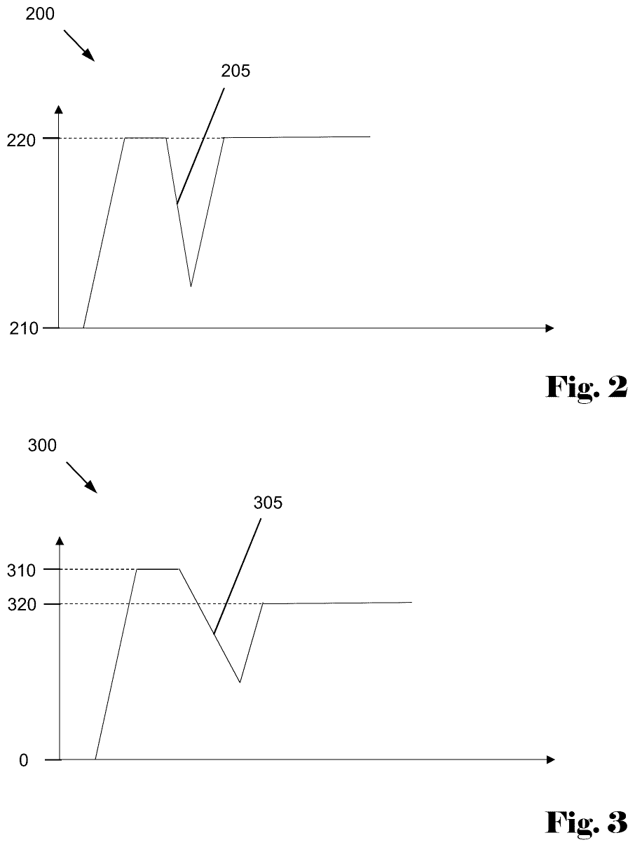

FIG. 2 schematically shows a characteristic 200 of a distance 205 traveled by a trigger, such as the trigger 130 shown in FIG. 1, during a fastening process over time. While being pulled by a user in a first pulling action, the trigger travels from a start position 210, where the trigger is not at all pulled, to an end position 220, corresponding to a stop limit where the trigger is completely pulled. The trigger may be spring-loaded into its start position 210. After a while, e.g. a few hundred milliseconds, the user releases the trigger, whereas the trigger travels back towards its start position 210. Just before the trigger arrives at its start position 210, the user pulls it to its end position 220 in a second pulling action. Then, the trigger is constantly held in its end position, such as for setting a screw into a workpiece.

A pattern according to which the trigger is pulled may be characterized in several ways: by the travelled distance of a pulling action, such as a percentage of the distance between the start position and the end position; by a speed of a pulling action, such as a slope of the distance 205 over time as shown in FIG. 2; by a duration of a pulling action, such as along the horizontal axis in FIG. 2; by a number of pulling actions within a predefined time interval (in FIG. 2, two pulling actions are shown); by a time interval between two pulling actions, such as along the horizontal axis in FIG. 2; by a frequency of pulling actions, such as along the horizontal axis in FIG. 2; or by a combination thereof. The pattern according to which the trigger is pulled is determined by a controller, such as the controller 140 shown in FIG. 1. The pattern may be determined physically, i.e. by using one or more sensors, or electronically, i.e. by performing a software algorithm.

FIG. 3 schematically shows a characteristic 300 of a parameter 305 of an operating motor, such as the motor 110 shown in FIG. 1, during a fastening process over time. The parameter 305 may be a voltage of an electric current provided to the motor, a maximum amperage of the electric current provided to the motor, a maximum rotational speed of the motor, or a combination thereof. A controller, such as the controller 140 shown in FIG. 1, changes the value of the parameter 305 upon a change of the position 205 of the trigger as shown in FIG. 2. In the embodiment shown, the parameter 305 rises from 0 to a first maximum value 310 (a first mode of operation) upon the first pulling action. At this time, the controller recognizes only a single pulling action (a first pattern). Upon releasing the trigger, the parameter 305 decreases towards 0. Upon the second pulling action within a certain time interval, the controller recognizes two pulling actions within a predefined time interval (a second pattern) and switches to a second mode of operation, in which the parameter rises to a second maximum value 320 which is smaller than the first maximum value 310. Additionally, the controller may switch to a third mode of operation in which the parameter 305 rises to a third maximum value upon a third pulling action within the same time interval.

In some embodiments, the controller is further configured to memorize which mode of operation the motor is controlled to run in and define such a mode as the first mode of operation for a subsequent execution of the method. Further, the controller may be configured to use a memorized mode of operation as the first mode of operation, and a mode of operation immediately following the memorized mode of operation within a predefined cyclic order of modes of operation as the second mode of operation.

Throughout the present application, “current provided to the motor” is meant to include current that is measured within a power supply, such as a battery, if the hand-held power tool is a battery-operated tool.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be distributed among modules that differ in number and distribution of functionality from those described herein. Additionally, the order of execution of the functions may be changed depending on the embodiment. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A method for running a machine to set a screw along a setting axis into a workpiece, wherein the machine comprises a motor configured to provide rotational energy to the screw and a trigger configured to be pulled by a user of the machine, the method comprising:
providing electrical current to the motor to run the motor at a rotational speed and a torque upon pulling the trigger;
determining a pattern according to which the trigger is pulled;
controlling the motor to run in a first mode of operation if the trigger is pulled according to a first pattern;
controlling the motor to run in a second mode of operation if the trigger is pulled according to a second pattern.

2. The method according to claim 1, wherein the second mode of operation is different from the first mode of operation in terms of at least one of a voltage of electric current provided to the motor, a maximum amperage of the electric current provided to the motor, a maximum rotational speed of the motor, and a combination thereof.

3. The method according to claim 1, wherein the second pattern is different from the first pattern in terms of at least one of a travelled distance of a pulling action, a speed of the pulling action, a duration of a pulling action, a number of pulling actions within a predefined time interval, a time interval between two pulling actions, a frequency of pulling actions, and a combination thereof.

4. The method according to claim 1, wherein the pattern according to which the trigger is pulled is determined electronically.

5. The method according to claim 1, further comprising controlling the motor to run in a third mode of operation if the trigger is pulled according to a third pattern.

6. The method according to claim 1, further comprising memorizing which mode of operation the motor is controlled to run in and defining the mode of operation as the first mode of operation for a subsequent execution of the method.

7. The method according to claim 6, wherein a memorized mode of operation of a previous execution of the method is used as the first mode of operation, and a mode of operation immediately following the memorized mode of operation within a predefined cyclic order of modes of operation is used as the second mode of operation.

8. A machine for setting a screw along a setting axis into a workpiece, comprising:
a motor configured to provide rotational energy to the screw;
a trigger configured to be pulled by a user of the machine;
a controller configured to provide electrical current to the motor to run the motor at a rotational speed and a torque upon pulling the trigger, determine a pattern according to which the trigger is pulled, control the motor to run in a first mode of operation if the trigger is pulled according to a first pattern, and control the motor to run in a second mode of operation if the trigger is pulled according to a second pattern.

9. The machine according to claim 8, wherein the controller is further configured to one or more of:
electronically determine the pattern according to which the trigger is pulled;
control the motor to run in a third mode of operation if the trigger is pulled according to a third pattern;
memorize which mode of operation the motor is controlled to run in and define the mode of operation as the first mode of operation for a subsequent execution of the method;
use a memorized mode of operation as the first mode of operation, and a mode of operation immediately following the memorized mode of operation within a predefined cyclic order of modes of operation as the second mode of operation.

10. The method according to claim 2, wherein the second pattern is different from the first pattern in terms of at least one of a travelled distance of a pulling action, a speed of the pulling action, a duration of a pulling action, a number of pulling actions within a predefined time interval, a time interval between two pulling actions, a frequency of pulling actions, and a combination thereof.

11. The method according to claim 2, wherein the pattern according to which the trigger is pulled is determined electronically.

12. The method according to claim 2, further comprising controlling the motor to run in a third mode of operation if the trigger is pulled according to a third pattern.

13. The method according to claim 2, further comprising memorizing which mode of operation the motor is controlled to run in and defining the mode of operation as the first mode of operation for a subsequent execution of the method.

14. The method according to claim 13, wherein a memorized mode of operation of a previous execution of the method is used as the first mode of operation, and a mode of operation immediately following the memorized mode of operation within a predefined cyclic order of modes of operation is used as the second mode of operation.

15. The method according to claim 3, wherein the pattern according to which the trigger is pulled is determined electronically.

16. The method according to claim 3, further comprising controlling the motor to run in a third mode of operation if the trigger is pulled according to a third pattern.

17. The method according to claim 3, further comprising memorizing which mode of operation the motor is controlled to run in and defining the mode of operation as the first mode of operation for a subsequent execution of the method.

18. The method according to claim 17, wherein a memorized mode of operation of a previous execution of the method is used as the first mode of operation, and a mode of operation immediately following the memorized mode of operation within a predefined cyclic order of modes of operation is used as the second mode of operation.
